(19) United States
(12) Patent Application Publication
(10) Pub. No.: US 2016/0188036 A1
(43) Pub. Date: Jun. 30, 2016

(54) TOUCH SENSING APPARATUS AND DRIVING METHOD THEREOF

(71) Applicant: Samsung Display Co. Ltd., Yongin-City (KR)

(72) Inventors: Soon Sung AHN, Chungcheongnam-do (KR); Joo Hyung LEE, Gwacheon-si (KR); Hyoung Wook JANG, Anyang-si (KR)

(21) Appl. No.: 14/720,602

(22) Filed: May 22, 2015

(30) Foreign Application Priority Data
Dec. 29, 2014 (KR) 10-2014-0192266

(51) Int. Cl. G06F 3/044; G09G 5/18

(52) U.S. Cl. CPC G06F 3/044; G09G 5/18

(57) ABSTRACT

A touch sensing apparatus is provided. A touch sensing apparatus comprises a panel comprising a plurality of driving electrodes and a plurality of sensing electrodes crossing the driving electrodes, a driving circuit unit simultaneously applying the driving signals to the driving electrodes in a certain interval and a sensing circuit unit sensing a change in capacitance occurring in intersecting points between the driving electrodes having the driving signals applied thereto and the sensing electrodes, wherein, when a driving waveform of the driving signal applied to the driving electrode in a (2k−1)-th interval and a (2k+1)-th interval (k is a natural number greater than 1) of the certain interval is in the same phase, the driving circuit unit applies a reverse driving signal of the driving waveform of the driving signal of the (2k−1)-th interval to the driving electrode in a 2k interval.

This application claims priority from Korean Patent Application No. 10-2014-0192266 filed on Dec. 29, 2014 in the Korean Intellectual Property Office, the disclosure of which is incorporated herein by reference in its entirety.

### TECHNICAL FIELD

The present inventive concept relates generally to a touch sensing apparatus and a driving method thereof.

### BACKGROUND

A Liquid Crystal Display (LCD) or an Organic LED (OLED) employs a touch panel as an input device. Users input a command by touching the touch panel with a user's fingers or an object such as pen. The touch panel can be categorized largely into a resistive type and a capacitive type based on a touch input method. The capacitive type features a relatively long lifespan, various input methods, and easy gesture input, and thus its application has been widely applied to devices such as smart phone, and the like.

The capacitive touch screen include a plurality of driving electrodes and a plurality of sensing electrodes, and can determine whether the touch is input based on a capacitive change generated between the driving electrodes and the sensing electrodes.

### SUMMARY

The present inventive concept provides a touch sensing apparatus for reducing a driving signal application time, that is, a driving time and increasing sensing accuracy.

Another aspect of the present inventive concept is to provide a driving method of a touch sensing apparatus for reducing a driving time and increasing sensing accuracy.

However, aspects of the present inventive concept are not restricted to the one set forth herein. The above and other aspects of the present inventive concept will become more apparent to one of ordinary skill in the art to which the present inventive concept pertains by referencing the detailed description of the present inventive concept given below.

According to an aspect of the present inventive concept, a touch sensing apparatus comprising a panel comprising a plurality of driving electrodes and a plurality of sensing electrodes crossing the driving electrodes, a driving circuit unit simultaneously applying the driving signals to the driving electrodes in a certain interval and a sensing circuit unit sensing change in capacitance occurring in intersecting points between the driving electrodes having the driving signals applied thereto and the sensing electrodes, wherein, when a driving waveform of the driving signal applied to the driving electrode in a (2k−1)-th interval and a (2k+1)-th interval (k is a natural number greater than 1) of the certain interval is in the same phase, the driving circuit unit applies a reverse driving signal of the driving waveform of the driving signal of the (2k−1)-th interval to the driving electrode in a 2k interval.

The node capacitor is charged by a positive voltage in a first mode and a negative voltage in a second mode, and a driving waveform of the first mode and a driving waveform of the second mode are reversed.

When the driving signal applied to the driving electrode in the (2k−1)-th interval and the (2k+1)-th interval has the driving waveform of the first mode, the driving circuit unit applies the driving signal of the driving waveform of the second mode to the driving electrode in the 2k interval.

When the driving signal applied to the driving electrode in the (2k−1)-th interval and the (2k+1)-th interval has the driving waveform of the second mode, the driving circuit unit applies the driving signal of the driving waveform of the first mode to the driving electrode in the 2k interval.

When the driving waveform of the driving signal applied to the driving electrode in the (2k−1)-th interval and the (2k+1)-th interval is reversed, the driving circuit unit applies the driving signal of a direct current (DC) waveform to the driving electrode in the 2k interval.

The driving circuit unit generates the driving signals according to a driving matrix comprising N rows corresponding to the number of the driving electrodes and M columns corresponding to the number of subintervals of the certain interval (N and M are natural numbers greater than 1), and the driving matrix comprises an element of 1 when the node capacitor is charged by the positive voltage and an element of −1 when the node capacitor is charged by the negative voltage in the subinterval.

The driving matrix comprises an element of 0 when the driving waveform of the driving signal applied to the node capacitor is a direct current (DC) waveform.

The driving matrix comprises a 2k-th row element of −1 when a (2k−1)-th row element and a (2k+1)-th row element of the same column are the same as 1, and the 2k-th row element of 1 when the (2k−1)-th row element and the (2k+1)-th row element are the same as −1 in a matrix generated based on a Walsh sequence.

The driving matrix comprises a 2k-th row element of 0 when a (2k−1)-th row element and a (2k+1)-th row element of the same column are different from each other in matrix generated based on a Walsh sequence.

In other aspect of the present inventive concept, a touch sensing apparatus comprising a panel comprising a plurality of driving electrodes, a plurality of sensing electrodes crossing the driving electrodes, and a plurality of node capacitors occurring in intersecting points between the driving electrodes having the driving signals applied to and the sensing electrodes and a driving circuit unit applying the driving signals to the node capacitors in a certain interval, wherein, when a polarity of a voltage charged to the node capacitor in a (2k−1)-th interval and a (2k+1)-th interval (k is a natural number greater than 1) of a certain interval is the same, the driving circuit unit applies the driving signal to the node capacitor so as to produce in a 2k interval a different polarity from the polarity of the voltage charged to the node capacitor of the (2k−1)-th interval.

The driving signal comprises one of a first mode driving waveform for applying a positive voltage to the node capacitor, a second mode driving waveform for applying a negative voltage to the node capacitor, and a third mode driving waveform for applying a direct current (DC) voltage to the node capacitor.

The first mode driving waveform and the second mode driving waveform are reversed.

When the polarity of the voltage charged to the node capacitor in the (2k−1)-th interval and the (2k+1)-th interval (k is a natural number greater than 1) is different, the driving circuit unit applies the driving signal of the third mode driving waveform to the node capacitor in the 2k interval.

The driving circuit unit generates the driving signals according to a driving matrix comprising N rows corresponding to the number of the driving electrodes and M columns corresponding to the number of subintervals of the certain interval (N and M are natural numbers greater than 1), and the driving matrix comprises an element of 1 when the node capacitor is charged by the positive voltage and an element of −1 when the node capacitor is charged by the negative voltage in the subinterval.

The driving matrix comprises an element of 0 when the driving signal of the third mode driving waveform is applied to the node capacitor in the subinterval.

When a (2k−1)-th row element and a (2k+1)-th row element of the same column are the same as 1 in a matrix generated according to a Walsh sequence, the driving matrix comprises a 2k-th row element of −1, when the (2k−1)-th row element and the (2k+1)-th row element are the same as −1, the driving matrix comprises the 2k-th row element of 1, and when the (2k−1)-th row element and the (2k+1)-th row element are different from each other, the driving matrix comprises the 2k-th row element of 0.

The touch sensing apparatus further comprises a sensing circuit unit sensing a change in capacitance of the node capacitors and a processing unit determining a touch input based on the capacitance change.

According to an aspect of the present inventive concept, a method for driving a touch sensing apparatus, comprising applying a plurality of driving signals to a plurality of node capacitors in a certain interval, generating a plurality of sensing signals by sensing a change in capacitance of the node capacitors per driving time of the certain interval and determining a touch input using the sensing signals measured per driving time, wherein, when a driving waveform of the driving signal applied to the node capacitor in a (2k−1)-th interval and a (2k+1)-th interval (k is a natural number greater than 1) of the driving time is in the same phase, the applying of the driving signals applies a reverse driving signal of the driving waveform of the driving signal of the (2k−1)-th interval to the node capacitor in a 2k interval.

When the driving waveform of the driving signal applied to the node capacitor in the (2k−1)-th interval and the (2k+1)-th interval is reversed, the applying of the driving signals applies the driving signal of a direct current waveform to the node capacitor in the 2k interval.

The applying of the driving signals generates the driving signals according to a driving matrix comprising N rows corresponding to the number of the node capacitors and M columns corresponding to the number of the driving times (N and M are natural numbers greater than 1), and the driving matrix comprises an element of 1 when the node capacitor is charged by a positive voltage and an element of −1 when the node capacitor is charged by a negative voltage, at one driving time.

Other features and exemplary embodiments will be apparent from the following detailed description, the drawings, and the claims.

### BRIEF DESCRIPTION OF THE DRAWINGS

The above and other aspects and features of the present inventive concept will become more apparent by describing in detail exemplary embodiments thereof with reference to the attached drawings, in which:

FIG. 1 is a perspective view of an exterior of an electronic device including a touch sensing apparatus according to an exemplary embodiment of the present inventive concept;

FIG. 2 is a diagram of a panel of the touch sensing apparatus according to an exemplary embodiment of the present inventive concept;

FIG. 3 is a cross-sectional view of a touch screen panel of the touch sensing apparatus of FIG. 2;

FIG. 4 is a block diagram of the touch sensing apparatus according to an exemplary embodiment of the present inventive concept;

FIG. 5 is a detailed circuit diagram of the touch sensing apparatus of FIG. 4;

FIG. 6 is a simplified diagram of the touch sensing apparatus of FIG. 4;

FIG. 7 is a circuit diagram of a driving circuit unit of the touch sensing apparatus of FIG. 4;

FIG. 8 is a diagram of driving waveforms of a driving signal in the touch sensing apparatus according to an exemplary embodiment of the present inventive concept;

FIGS. 9 and 10 are diagrams of a conventional touch sensing apparatus;

FIGS. 11, 12, and 13 are diagrams of generation of a driving matrix applied to the touch sensing apparatus according to an exemplary embodiment of the present inventive concept;

FIG. 14 is a diagram of the number of sensings compared between the conventional touch sensing device and the present touch sensing apparatus;

FIG. 15 is a flowchart of a driving method of the touch sensing apparatus according to an exemplary embodiment of the present inventive concept; and

FIG. 16 is a detailed flowchart of driving signal generation of the driving method of the touch sensing apparatus according to an exemplary embodiment of the present inventive concept.

### DETAILED DESCRIPTION OF THE INVENTIVE CONCEPT

Advantages and features of the present inventive concept and methods of accomplishing the same may be understood more readily by reference to the following detailed description of preferred embodiments and the accompanying drawings. The present inventive concept may, however, be embodied in many different forms and should not be construed as being limited to the embodiments set forth herein. Rather, these embodiments are provided so that this disclosure will be thorough and complete and will fully convey the concept of the inventive concept to those skilled in the art, and the present inventive concept will only be defined by the appended claims. Like reference numerals refer to like elements throughout the specification.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being “on”, “connected to” or “coupled to” another element or layer, it can be directly on, connected or coupled to the other element or layer or intervening elements or layers may be present between the element or layer and the another element or layer. In contrast, when an element is referred to as being “directly on”, “directly connected to” or “directly coupled to” another element or layer, there are no intervening elements or layers present between the element or layer and the another element or layer. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present inventive concept.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Embodiments are described herein with reference to cross-section illustrations that are schematic illustrations of idealized embodiments (and intermediate structures). As such, variations from the shapes of the illustrations as a result, for example, of manufacturing techniques and/or tolerances, are to be expected. Thus, these embodiments should not be construed as limited to the particular shapes of regions illustrated herein but are to include deviations in shapes that result, for example, from manufacturing. Thus, the regions illustrated in the figures are schematic in nature and their shapes are not intended to illustrate the actual shape of a region of a device and are not intended to limit the scope of the present inventive concept.

Unless otherwise defined, all terms (including technical and scientific terms) used herein have the same meaning as commonly understood by one of ordinary skill in the art to which the present inventive concept belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

Hereinafter, embodiments of the present inventive concept will be described with reference to the accompanying drawings.

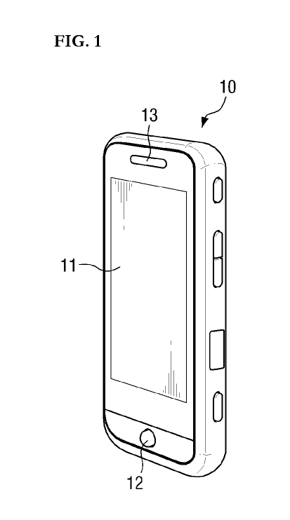

FIG. 1 is a perspective view of an exterior of an electronic device 10 including a touch sensing apparatus according to an exemplary embodiment of the present inventive concept.

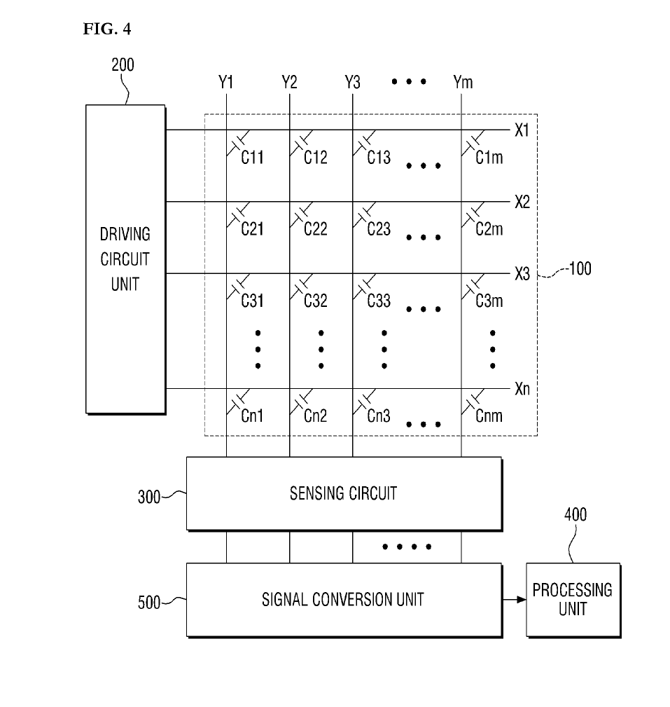

Referring to FIG. 1, the electronic device 10 can include a display device 11, an input part 12, and an audio part 13. The display device 11 can output a screen, and the audio part 13 can output voice. The electronic device 10 can further include a touch screen device (not shown) integrally formed with the display device 11. The touch screen device can include a panel 100 (FIG. 4) including a substrate and a plurality of electrodes disposed on the substrate, a driving circuit unit 200 (FIG. 4) for providing a plurality of driving signals to the electrodes, a sensing circuit unit 300 (FIG. 4) for measuring a capacitive change generated in the electrodes, an analog-digital signal conversion unit 500 (FIG. 4) for converting a sensing signal from the sensing circuit unit 300 (FIG. 4) to a digital value, and an processing unit 400 (FIG. 4) for determining the touch input using the converted digital value data.

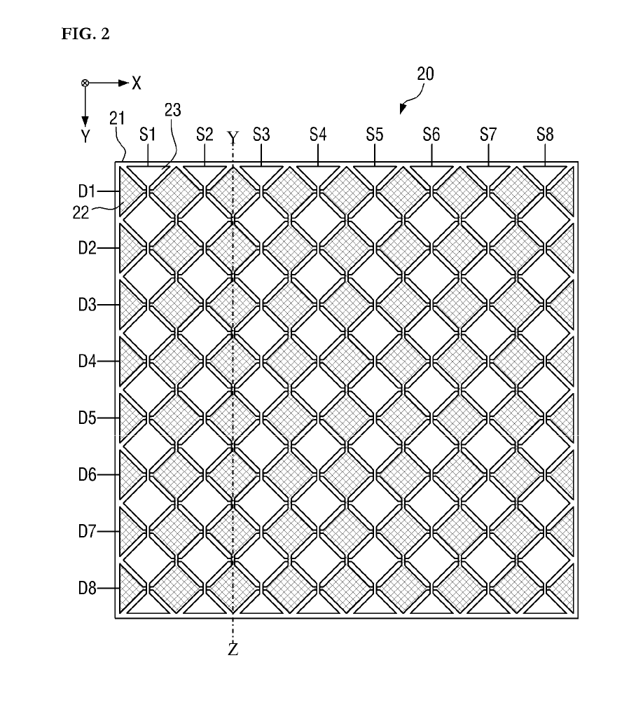

FIG. 2 is a diagram of the panel 100 of the touch sensing apparatus according to an exemplary embodiment of the present inventive concept.

Referring to FIG. 2, a touch screen panel 20 includes a substrate 21, a plurality of driving electrodes 22 on the substrate 21, and a plurality of sensing electrodes 23 crossing the driving electrodes 22. Although it is not depicted in FIG. 2, the driving electrodes 22 and the sensing electrodes 23 each can be electrically connected to a bonding pad of a flexible circuit board attached to one end of the substrate 21 via a wiring pattern and the bonding pad. The flexible circuit board can include a controller Integrated Circuit (IC) for determining the sensing signal generated by the driving electrodes 22 and the sensing electrodes 23 and determining the touch input based on the sensing signal.

The substrate 21 can be formed of a material such as film of Polyethylene terephthalate (PET), polycarbonate (PC), polyethersulfone (PES), polyimide (PI), Polymethlymethacrylate (PMMA), Cyclo-Olefin Polymers (COP), soda glass, or tempered glass.

The driving electrodes 22 and the sensing electrodes 23 can be disposed in one side of the substrate 21. Even the driving electrodes 22 and the sensing electrodes 23 form a rhombic or diamond pattern, the patter is, but not limited to, the rhombic or diamond pattern and can have various polygonal patterns such as rectangle or triangle. The driving electrodes 22 can extend along an X axis, and the sensing electrodes 23 can extend along a Y axis. The driving electrodes 22 and the sensing electrodes 23 can be disposed on one side or on both sides of the substrate 21, or on different substrates. When all of the driving electrodes 22 and the sensing electrodes 23 are on one side of the substrate 21, an insulating layer can be formed at intersections of the driving electrodes 22 and the sensing electrodes 23 to insulate the driving electrodes 22 and the sensing electrodes 23. The driving electrodes 22 can receive a plurality of driving signals from the driving circuit unit 200 (FIG. 4), to be explained, over channels D1 through D8. The sensing electrodes 23 can provide a plurality of sensing signals to the sensing circuit unit 300 (FIG. 4) over channels S1 through S8. The sensing signal can be generated using mutual-capacitance change generated between the driving electrodes 22 and the sensing electrodes 23.

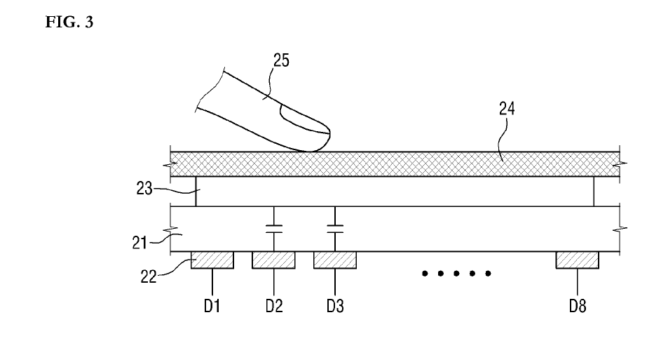

FIG. 3 is a cross-sectional view of the touch screen panel 20 of the touch sensing apparatus of FIG. 2. That is, FIG. 3 is a cross-sectional view of the touch screen panel 20 of FIG. 2, which is taken along Y-Z.

Referring to FIG. 3, the touch sensing apparatus can further include a cover lens 24 for directly receiving a user input 25. The cover lens 24 can be disposed on the sensing electrodes 23 for detecting the sensing signals. When the driving signals are applied to the driving electrodes 22 via the channels D1 through D8, the mutual-capacitance can be generated between the sensing electrodes 23 and the driving electrode 22. In this case, when the user's input 25 touches the cover lens 24, the capacitance of the mutual capacitance can be changed. The capacitance change can be proportional to an area of an object touching the cover lens 24. For example, the mutual capacitance generated between the driving electrode 22 and the sensing electrode 23 which are connected to the channels D2 and D3 respectively can be affected by the user input 25.

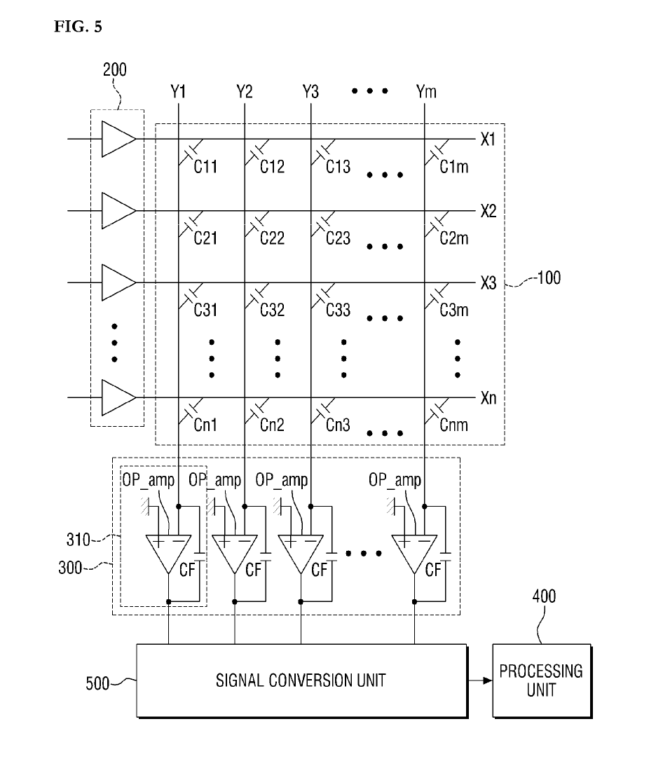

FIG. 4 is a block diagram of the touch sensing apparatus according to an exemplary embodiment of the present inventive concept. FIG. 5 is a detailed circuit diagram of the touch sensing apparatus of FIG. 4.

Referring to FIGS. 4 and 5, the touch sensing apparatus can include the panel 100, the driving circuit unit 200, the sensing circuit unit 300, the processing unit 400, and the signal conversion unit 500. The panel 100, the driving circuit unit 200, the sensing circuit unit 300, the processing unit 400, and the signal conversion unit 500 can be implemented using a single IC.

The panel 100 can include a plurality of row driving electrodes X1 through Xn extending in a first direction (the same direction as X1) and a plurality of column sensing electrodes Y1 through Ym extending in a second direction (the same direction as Y1) crossing the first direction. A plurality of node capacitors C11 through Cnm indicates the mutual capacitance generated at the intersections of the driving electrodes X1 through Xn and the sensing electrodes Y1 through Ym. While X1 through Xn denote the driving electrodes and Y1 through Ym denote the sensing electrodes, the driving electrodes can be referred to as driving electrode lines and the sensing electrodes can be referred to as sensing electrode lines.

The driving circuit unit 200 can be connected to the driving electrodes X1 through Xn and apply the driving signals. The driving signal can include square wave, sine wave, and triangle wave with certain period and amplitude. The driving circuit unit 200 can include a plurality of unit driving parts for applying the driving signals to the driving electrodes X1 through Xn respectively. The driving circuit unit 200 can apply the driving signals to the driving electrodes X1 through Xn individually. The driving circuit unit 200 may apply the driving signals to the driving electrodes X1 through Xn at the same time. The driving circuit unit 200 can sequentially apply the driving signals to the driving electrodes X1 through Xn. Hereafter, “the driving circuit unit 200 simultaneously applies the driving signals to the driving electrodes X1 through Xn” embraces applying the driving signal to the driving electrodes X1 through Xn at certain time intervals as well as at exactly the same time.

The sensing circuit unit 300 can be connected to the sensing electrodes Y1 through Ym. The sensing circuit unit 300 can measure the capacitance of the node capacitors C11 through Cnm from the sensing electrodes Y1 through Ym, and output a plurality of sensing signals. Referring to FIG. 5, the sensing circuit unit 300 can include a plurality of C-V signal conversion units 310. The C-V signal conversion unit 310 can be connected to the respective sensing electrode of the sensing electrodes Y1 through Ym. The C-V signal conversion unit 310 can convert the capacitance of the node capacitors C11 through Cnm to a voltage signal and output a plurality of analog sensing signals. For doing so, the C-V signal conversion unit 310 can include an integration circuit for integrating the capacitance. The integration circuit can include at least one operational amplifier (op-amp) and at least one integrating capacitor (CF). The op-amp can be a differential amplifier and can include an inverting input terminal connected to one of the sensing electrodes Y1 through Ym and a non-inverting input terminal connected to a ground. The integrating capacitor (CF) can be connected between the inverting input terminal of the op-amp and an output terminal of the op-amp. The integrating capacitor (CF) can negatively feed the output of the op-amp back to the input of the op-amp. The sensing circuit unit 300 can include the C-V signal conversion units 310 respectively connected to the sensing electrodes Y1 through Ym.

The signal conversion unit 500 generates the digital signal using the sensing signals output from the sensing circuit unit 300. For example, the signal conversion unit 500 can measure the time taken to reach a reference voltage level by the voltage level of the analog sensing signals output from the sensing circuit unit 300, and convert the time to the digital signal. For doing so, the signal conversion unit 500 can include a Time-to-Digital Signal conversion unit (TDC) circuit. Alternatively, the signal conversion unit 500 may include an Analog-to-Digital Signal conversion unit (ADC) circuit for measuring the change of the voltage level of the analog sensing signals output from the sensing circuit unit 300 over a certain time, and converting the time to the digital signal.

The processing unit 400 determines the touch input applied to the panel 100 using the digital signal fed from the signal conversion unit 500. That is, the processing unit 400 can determine the number of touch inputs, coordinates, and a gesture applied to the panel 100 using the digital signal. In so doing, the digital signal can be numerical data of the capacitance change measured by the node capacitors C11 through Cnm. Particularly, the digital signal can be data indicating the capacitance difference between no touch input and the touch input.

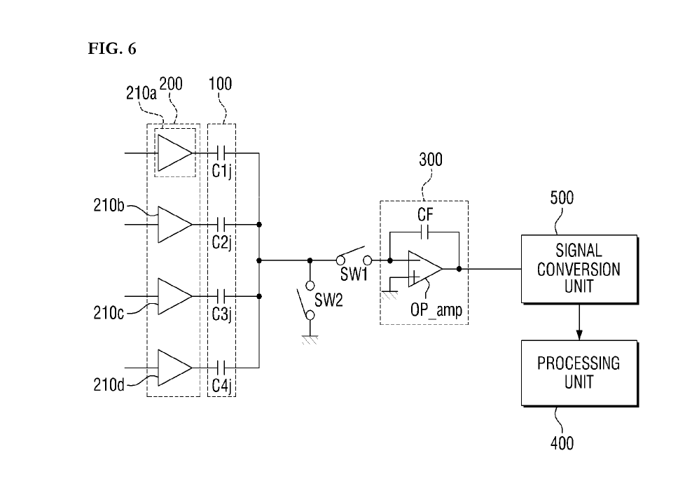

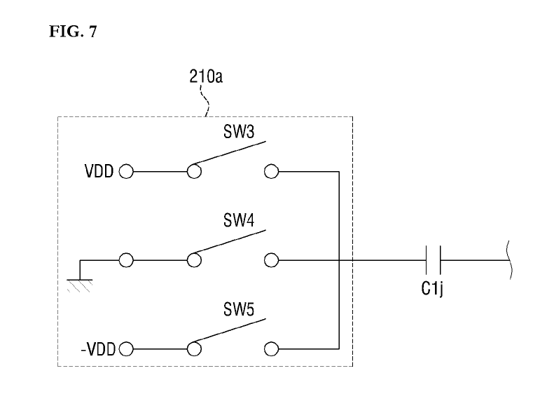

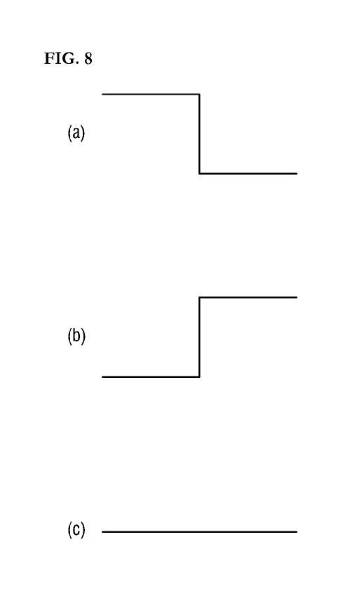

FIG. 6 is a simplified diagram of the touch sensing apparatus of FIG. 4. FIG. 7 is a circuit diagram of the driving circuit unit 200 of the touch sensing apparatus of FIG. 4. FIG. 8 is a diagram of driving waveforms of the driving signal in the touch sensing apparatus according to an exemplary embodiment of the present inventive concept.

Referring to FIGS. 6 and 7, the driving circuit unit 200 can include four unit driving parts 210a through 210d. The unit driving parts 210a through 210d can apply the driving signal to respective node capacitors C1j through C4j (j is a natural number greater than 1). While the number of the unit driving parts 210a through 210d is 4 in the exemplary embodiment but it can be adequately selected according to the number of the driving electrodes and the driving electrode lines. The touch sensing apparatus can further include first and second sensing switches SW1 and SW2. The first sensing switch SW1 can be connected between a common end of the node capacitors C1j through C4j and the inverting terminal of the op-amp. The first sensing switch SW1 can send the voltage charged in the node capacitors C1j through C4j to the CF through its switching operation. The second sensing switch SW2 can be connected between the common end of the node capacitors C1j through C4j and the ground.

The unit driving parts 210a through 210d can generate and apply the driving signal to the corresponding node capacitors C1j through C4j. More specifically, the unit driving parts 210a through 210d can generate the driving signal according to a driving matrix. The driving matrix can be generated by the driving circuit unit 200 or the processing unit 500 and provided to the driving circuit unit 200. The unit driving parts 210a through 210d can apply the driving signal having one of a first mode driving waveform for applying a positive voltage VDD, a second mode driving waveform for applying a negative voltage −VDD, and a third mode driving waveform for applying a direct current voltage DC, to the corresponding node capacitors C1j through C4j according to the driving matrix. Referring to FIG. 7, the unit driving part 210a can include the positive voltage VDD, the negative voltage −VDD, and first, second, and third driving switches SW3, SW4, and SW5. The first driving switch SW3 can be connected between a power source for applying the positive voltage VDD and one end of the node capacitor C1j. The second driving switch SW4 can be connected between the ground and one end of the node capacitor C1j. The third driving switch SW5 can be connected between a power source for applying the negative voltage −VDD and one end of the node capacitor C1j. The other unit driving units can include the above-stated structure. That is, the unit driving parts 210a through 210d each can generate the driving signal having the first mode driving waveform for applying the positive voltage VDD, the driving signal having the second mode driving waveform for applying the negative voltage −VDD, and the driving signal having the third mode driving waveform for applying the direct current voltage DC according to the driving matrix, and apply the driving signal to the corresponding node capacitor C1j through C4j according to the switching operations of the first, second, and third driving switches SW3, SW4, and SW5. In so doing, the voltage level of the positive voltage VDD and the negative voltage −VDD can be the same. Notably, the unit driving part 210a of FIG. 7 is a mere example and is not limited to the structure of FIG. 7. Circuit configuration of the unit driving parts may be different from each other.

Referring to FIG. 8, the first mode driving waveform is shown in FIG. 8A. That is, the first mode driving waveform can change from a high level to a low level. The second mode driving waveform is shown in FIG. 8B. That is, the second mode driving waveform can change from a low level to a low level. The second mode driving waveform may have inversed phase of the first mode driving waveform. As long as the phases of the first mode driving waveform and the second mode driving waveform have the reversed phase, the first mode driving waveform is not limited to the waveform of FIG. 8A and the second mode driving waveform is not limited to the waveform of FIG. 8B. The third mode driving waveform is shown in FIG. 8C. That is, the third mode driving waveform can be the DC voltage without having the waveform change. The continuous high potential and the continuous low potential of the DC voltage are classified to the third mode driving waveform. Now, a method for applying the driving signal having one of the first, second, and third mode driving waveforms is explained by referring to FIGS. 6 and 7. While the unit driving part 210a is explained by way of example for ease of understanding, the other unit driving parts can be operated same to the unit driving part 210a.

A method for applying the driving signal of the first mode driving waveform will be described. The third mode driving switch SW5 can remain turned off in the first mode. To charge the node capacitor C1j, the first driving switch SW3 and the first sensing switch SW1 can be turned on. The second driving switch SW4 and the second sensing switch SW2 can be turned off. Hence, the node capacitor C1j can be charged by the positive voltage VDD. Next, the node capacitor C1j can be discharged. That is, the first driving switch SW3 and the first sensing switch SW1 can be turned off, and the second driving switch SW4 and the second sensing switch SW2 can be turned on. Hence, the node capacitor C1j can be discharged to the ground potential. In so doing, the voltage charged to the node capacitor C1j can be transferred to the integrating capacitor CF through the operation. The voltage charged to the integrating capacitor CF can be given by Equation 1.

Vcf1=(C1j/CF)*VDD [Equation 1]

Vcf1 denotes the voltage charged in the integrating capacitor CF (hereafter, referred to as a first voltage), C1j denotes the capacitance of the node capacitor C1j, and CF denotes the capacitance of the integrating capacitor. Since the driving signal of the first mode driving waveform is applied to the node capacitor C1j in the first mode, the node capacitor C1j can be charged by the positive voltage VDD. As the node capacitor C1j is discharged to the ground potential, the integrating capacitor CF can be charged by the first voltage Vcf1.

Next, the method for applying the driving signal of the second mode driving waveform will be described. The first driving switch SW3 can remain turned off in the second mode. To charge the node capacitor C1j, the third driving switch SW5 and the first sensing switch SW1 can be turned on. The second driving switch SW4 and the second sensing switch SW2 can be turned off. Hence, the node capacitor C1j can be charged by the negative voltage −VDD. Next, the node capacitor C1j can be discharged. That is, the third driving switch SW5 and the first sensing switch SW1 can be turned off, and the second driving switch SW4 and the second sensing switch SW2 can be turned on. Hence, the node capacitor C1j can be discharged to the ground potential. In so doing, the voltage charged in the node capacitor C1j can be transferred to the integrating capacitor CF through a certain operation. The voltage charged in the integrating capacitor CF can be given by Equation 2.

Vcf2=(CU/CF)*−VDD [Equation 2]

Vcf2 denotes the voltage charged in the integrating capacitor CF (hereafter, referred to as a second voltage). Since the driving signal of the second mode driving waveform is applied to the node capacitor C1j in the second mode, the node capacitor C1j can be charged by the negative voltage −VDD. As the node capacitor C1j is discharged to the ground potential, the integrating capacitor CF can be charged by the second voltage Vcf2.

The driving signal of the third mode driving waveform can be applied to the node capacitor C1j by regulating the turn-on or the turn-off period of the first, second, and third driving switches SW3, SW4, and SW5 and the first and second sensing switches SW1 and SW2. That is, in the third mode, the DC voltage DC can be applied to the node capacitor C1j.

As described above, the driving circuit unit 200 can generate the driving signals according the driving matrix. The driving matrix can have an element ‘1’ for the driving signal of the first mode driving waveform applying the positive voltage VDD to the node capacitor. The driving matrix can have an element ‘−1’ for the driving signal of the second mode driving waveform applying the negative voltage −VDD to the node capacitor. The driving matrix can have an element ‘0’ for the driving signal of the third mode driving waveform applying the direct current voltage DC to the node capacitor. Accordingly, the elements ‘1’ and ‘−1’ of the driving matrix indicate that the different voltages with 180-degree phase difference are applied to the node capacitor.

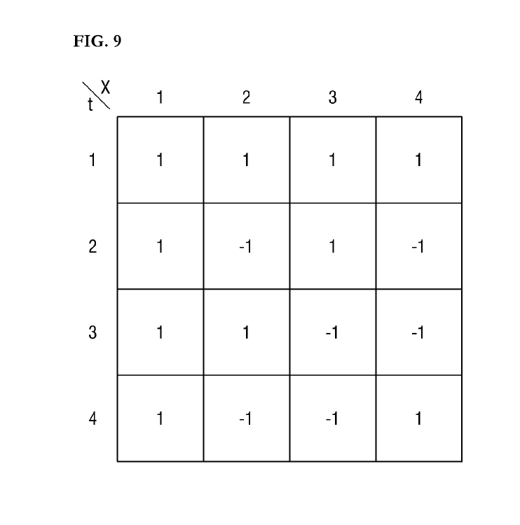

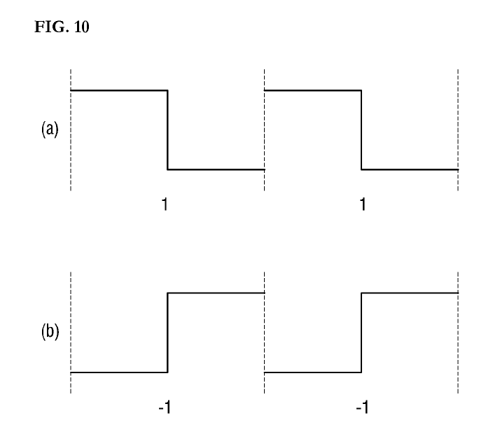

FIGS. 9 and 10 are diagrams of a conventional touch sensing apparatus. Hereafter, it is assumed that four unit driving parts X1 through X4 apply the driving signal to the driving electrodes and the driving signals are applied to the driving electrodes at first through fourth driving times t1 through t4. That is, the driving signals generated according to first through fourth row elements corresponding to the same column can be applied to the four unit driving parts X1 through X4 at the same time.

FIG. 9 depicts the driving matrix of 4 rows*4 columns generated by a Walsh sequence. For example, the driving signal corresponding to ‘1’ can be applied to the driving electrode X1 at the time t1 and the driving signal corresponding to ‘1’ can be applied to the driving electrode X1 at the time t2 as shown in FIG. 10A. In the conventional touch screen apparatus, because a transition from a high level to a low level corresponds to ‘1” and a low level to a high level corresponds to ‘−1”, to change the low potential level at the time t1 to the high potential level at the time t2, a conventional driving circuit unit needs to apply a separate signal (hereafter, referred to as a dummy signal) of the high potential level between the time t1 and the time t2, to the driving electrode X1. In more detail, the conventional driving circuit needs to apply the dummy signal having the driving waveform corresponding to ‘−1’ between the time t1 and the time t2, to the driving electrode X1. The time for the driving circuit unit to apply the dummy signal cannot contribute to sense for determining whether the capacitance actually changes. That is, although the conventional driving circuit unit applies the driving signals three times, the actual capacitance change is determined only two times except the dummy signal. Likewise, since the driving signal corresponding to ‘−1’ is applied at the time t3 and the time t4 for the driving electrode X3 as shown in FIG. 10B, the conventional driving circuit unit needs to apply the dummy signal of the driving waveform corresponding to ‘1’ to the driving electrode X3 between the time t3 and the time t4.

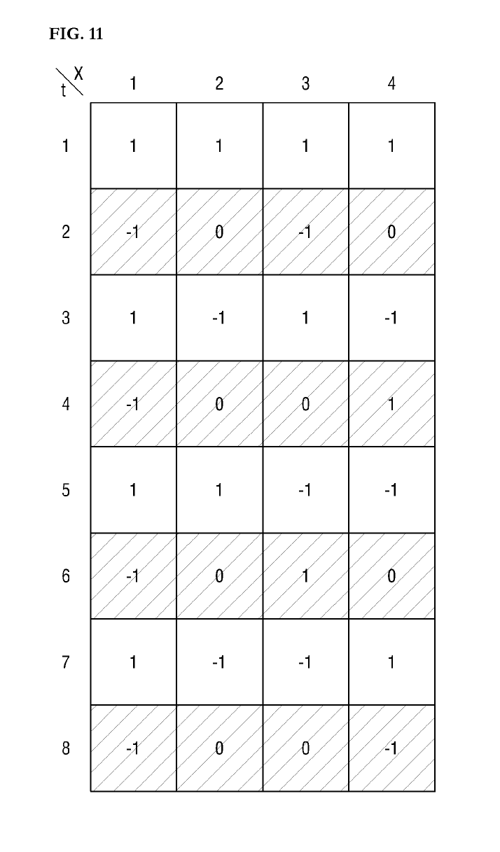

FIGS. 11, 12, and 13 are diagrams of the generation of the driving matrix applied to the touch sensing apparatus according to an exemplary embodiment of the present inventive concept.

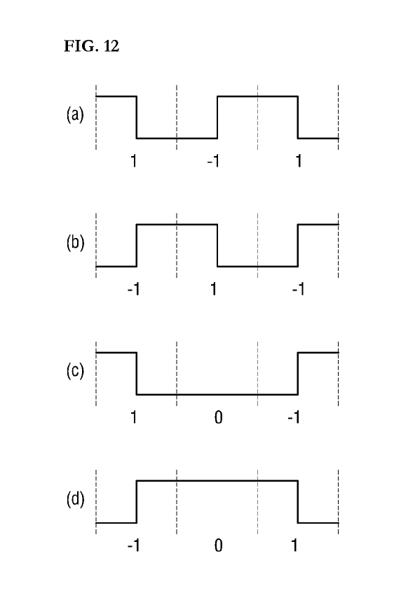

The driving matrix of FIG. 11 can be generated by adding some rows to the driving matrix of FIG. 9. For example, the driving matrix of FIG. 11 can include the element ‘−1’ at the time t2 because the elements of the time t1 and the time t3 are the same as 1′ based on the driving matrix X1 as shown in FIG. 12A. The driving matrix of FIG. 11 can include the element 1′ at the time t6 because the elements of the time t5 and the time t7 are the same as ‘−1’ based on the driving matrix X3 as shown in FIG. 12B. In conclusion, when a (2k−1)-th element and a (2k+1)-th element (k is a natural number greater than 1) are the same in a certain interval (t1 through t8 in FIG. 11), a 2k-th element can differ from the (2k−1)-th (or (2k+1)-th) element in the driving matrix. In this case, the different element of the 2k-th element can have the reverse driving waveform of the driving waveform of the (2k−1)-th element and the (2k+1)-th element. Hence, when the (2k−1)-th element and the (2k+1)-th element are 1′, the 2k-th element can be ‘−1’. When the (2k−1)-th element and the (2k+1)-th element are ‘−1’, the 2k-th element can be ‘1’. In other words, when the in-phase driving waveform of the driving signal is applied to one driving electrode in the (2k−1)-th interval and the (2k+1)-th interval (k is a natural number greater than 1) of the a certain interval (t1 through t8 in FIG. 11), the driving circuit unit 200 of FIG. 6 can provide a driving signal having a reversed phase of the driving waveform of the driving signal applied to the one driving electrode in the (2k−1)-th (or (2k+1)-th) interval, to the one driving electrode in the 2k interval. Eventually, when the voltage charged in the node capacitor in the (2k−1)-th interval and the (2k+1)-th interval (k is a natural number greater than 1) of the certain interval (t1 through t8 of FIG. 11) is the positive voltage VDD, that is, when the diving signal of the first mode driving waveform is applied, the voltage charged in the node capacitor in the 2k interval can be the negative voltage −VDD, that is, the driving signal of the second mode driving waveform can be applied. When the voltage charged in the node capacitor in the (2k−1)-th interval and the (2k+1)-th interval is the negative voltage −VDD, the voltage charged in the node capacitor in the 2k interval can be the positive voltage VDD.

Based on the driving electrode X2, since the elements of the time t1 and the time t3 are 1′ and ‘−1’ respectively, the driving matrix of FIG. 11 can include the element ‘0’ at the time t2 as shown in FIG. 12C. Since the elements of the time t3 and the time t5 of the driving electrode X2 are ‘−1’ and ‘1’ respectively, the driving matrix of FIG. 11 can include the element ‘0’ at the time t4 as shown in FIG. 12D. In conclusion, when the elements of the (2k−1)-th interval and the (2k+1)-th interval (k is a natural number greater than 1) of the certain interval (t1 through t8 of FIG. 11) are different from each other, the present driving matrix can include ‘0’ in the 2k interval. That is, the driving signal of the DC waveform can be applied to the driving electrode X2 in the 2k interval. Thus, when the elements of the (2k−1)-th interval and the (2k+1)-th interval are ‘1’ and ‘−1’ respectively, the element of the 2k interval can be ‘0’. When the elements of the (2k−1)-th interval and the (2k+1)-th interval are ‘−1’ and ‘1’ respectively, the element of the 2k interval can be ‘0’ as well. In other words, when the driving waveform of the driving signal applied to one driving electrode in the (2k−1)-th interval and the (2k+1)-th interval (k is a natural number greater than 1) of the certain interval (t1 through t8 of FIG. 11) are reversed, the driving circuit unit 200 of FIG. 6 can apply the driving signal of the DC waveform to the one driving electrode in the 2k interval. Eventually, when the voltage charged in the node capacitor in the (2k−1)-th interval and the (2k+1)-th interval (k is a natural number greater than 1) of the certain interval (t1 through t8 of FIG. 11) is the positive voltage VDD and the negative voltage −VDD respectively, the DC voltage can be charged to the node capacitor in the 2k interval. When the voltage charged to the node capacitor in the (2k−1)-th interval and the (2k+1)-th interval is the negative voltage −VDD and the positive voltage VDD respectively, the DC voltage can be charged to the node capacitor in the 2k interval. That is, even though the DC voltage charge to the node capacitor in the 2k interval can have different value, the driving signal of the third mode driving waveform can be applied to the sensing circuit unit 300. Ultimately, the sensing circuit unit 300 is idle in the interval where the driving signal of the third mode driving waveform is applied. Yet, the idle state of the sensing circuit unit 300, that is, the driving matrix element ‘0’ is not necessary and can be omitted in some cases.

While the driving matrix of FIG. 11 is generated according to, but not limited to, the Walsh sequence of the code length 4, the driving matrix can be generated from the Walsh sequence of various code lengths. Besides the Walsh sequence, the driving matrix can use pseudo-random-bit-stream and pseudo-orthogonal code.

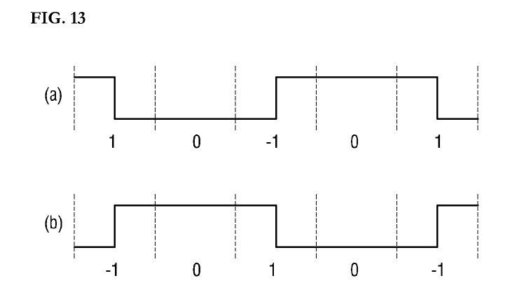

Alternatively, referring to FIG. 13, when a (2k−2)-th element and a (2k+2)-th element (k is a natural number greater than 1) of the certain interval (t1 through t8 of FIG. 11) are the same, the 2k element can be different from the (2k−2)-th (or the (2k+2)-th) element in the driving circuit unit 200 of FIG. 6. In this case, both of the (2k−1)-th element and the (2k+1)-th element can be ‘0’. That is, unlike the driving matrix of FIG. 12, the driving matrix can add at least one row of the element ‘0’. Thus, the idle state of the sensing circuit unit 300 can be added to appropriately control a reset period of the integrating capacitor CF, that is, the voltage discharging period.

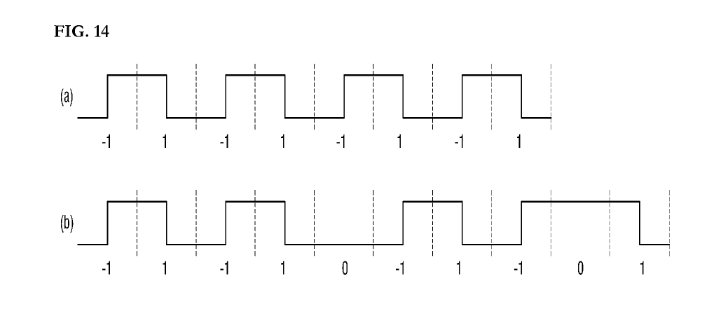

FIG. 14 is a diagram for comparing the number of the sensing times between the conventional touch sensing device of FIG. 14(A) and the present touch sensing apparatus of FIG. 14(B). Table 1 shows the comparisons of FIG. 14. At this time, it is assumed that the sequence is 1, 1, −1, −1, and 1. The non-sensing time in FIG. 14(A) is indicated by ‘X’.

TABLE 1

| driving time | FIG. 14A | FIG. 14B |
|---|---|---|
| t1 | X | −1 |
| t2 | 1 | 1 |
| t3 | X | −1 |
| t4 | 1 | 1 |
| t5 | −1 | 0 (idle) |
| t6 | X | −1 |
| t7 | −1 | 1 |
| t8 | 1 | −1 |
| t9 | — | 0 (idle) |
| t10 | — | 1 |

Referring to FIG. 14 and Table 1, 10 driving times in total contributing to the actual sensing for 5 times (t2, t4, t5, t7, and t8) in FIG. 14A and for 8 times (t1, t2, t3, t4, t6, t7, t8, and t10) except two idle times (t5 and t9) in FIG. 14B. That is, even with the same sequence, the present touch sensing apparatus of FIG. 14B achieves more sensing times than the conventional touch sensing device. Hence, the present touch sensing apparatus can enhance a Signal to Noise Ratio (SNR) compared to the conventional device. In addition, the idle period can attain the enough reset time of the integrating capacitor CF.

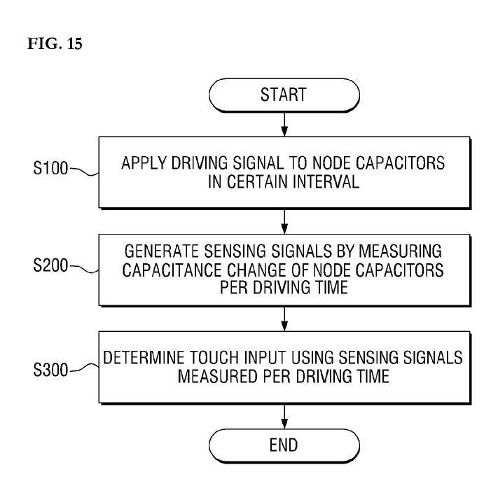

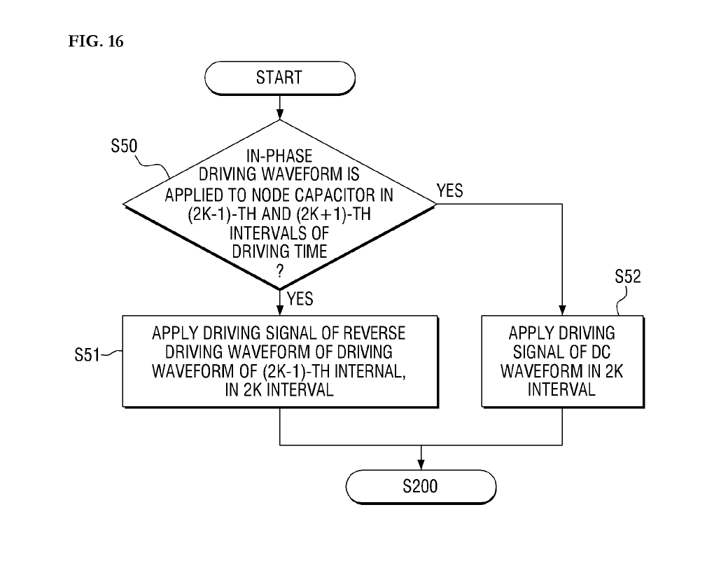

FIG. 15 is a flowchart of a driving method of the touch sensing apparatus according to an exemplary embodiment of the present inventive concept. FIG. 16 is a detailed flowchart of the driving signal generation of the driving method of the touch sensing apparatus according to an exemplary embodiment of the present inventive concept. Now, the driving method of the touch sensing apparatus is described based on FIG. 6.

Referring to FIGS. 6 and 15, the driving circuit unit 200 can apply the driving signals to the plurality of the node capacitors C1j through C4j in a certain interval in S100. In S200, the sensing circuit unit 300 can generate the sensing signals by measuring the capacitance change of the node capacitors C1j through C4j per driving time of the certain interval. The processing unit 400 can determine the touch input to the panel 100 using the generated sensing signals in S300.

In so doing, the driving circuit unit 200 can apply the driving signals according to the driving matrix, and the driving matrix can include N rows corresponding to the number of the node capacitors C1j through C4j and M columns corresponding to the number of the driving times in the certain interval (N and M are natural numbers greater than 1). The driving matrix can include the element ‘1’ when the node capacitor is charged by the positive voltage VDD and the element ‘−1’ when the node capacitor is charged by the negative voltage −VDD. The driving matrix can include the element ‘0’ when the DC voltage is applied to the node capacitor.

Referring to FIGS. 6 and 16, when the (2k−1)-th element and the (2k+1)-th element (k is a natural number greater than 1) are the same in the certain interval (t1 through t8 in FIG. 11) of the driving time, the 2k-th element can differ from the (2k−1)-th (or (2k+1)-th) element in the driving matrix. In this case, the different element of the 2k-th element can have the reverse driving waveform of the driving waveform of the (2k−1)-th element and the (2k+1)-th element. That is, when the in-phase driving waveform of the driving signal is applied to one driving electrode in the (2k−1)-th interval and the (2k+1)-th interval (k is a natural number greater than 1) in the certain interval (t1 through t8 in FIG. 11) in S50, the driving circuit unit 200 of FIG. 6 can provide the reverse driving signal of the driving waveform of the driving signal applied to the one driving electrode in the (2k−1)-th (or (2k+1)-th) interval, to the one driving electrode in the 2k interval in S51.

When the (2k−1)-th element and the (2k+1)-th element (k is a natural number greater than 1) are different from each other in the certain interval (t1 through t8 in FIG. 11), the driving matrix can include ‘0’ in the 2k-th interval. That is, when the reverse driving waveform of the driving signal is applied to one driving electrode in the (2k−1)-th interval and the (2k+1)-th interval (k is a natural number greater than 1) in the certain interval (t1 through t8 in FIG. 11), the driving circuit unit 200 of FIG. 6 can apply the driving signal of the DC waveform to the one driving electrode in the 2k interval in S52.

As set forth above, the driving time of the touch sensing apparatus can be reduced, and the sensing accuracy can be raised by increasing the number of the driving signals contributing to the sensing.

In addition, the SNR can be enhanced.

However, the effects of the present inventive concept are not restricted to the one set forth herein. The above and other effects of the present inventive concept will become more apparent to one of daily skill in the art to which the present inventive concept pertains by referencing the claims.

What is claimed is:

1. A touch sensing apparatus comprising:
a panel comprising a plurality of driving electrodes and a plurality of sensing electrodes crossing the driving electrodes;
a driving circuit unit simultaneously applying the driving signals to the driving electrodes in a certain interval; and
a sensing circuit unit sensing a change in capacitance occurring in intersecting points between the driving electrodes having the driving signals applied thereto and the sensing electrodes,
wherein, when a driving waveform of the driving signal applied to the driving electrode in a (2k−1)-th interval and a (2k+1)-th interval (k is a natural number greater than 1) of the certain interval is in the same phase, the driving circuit unit applies a reverse driving signal of the driving waveform of the driving signal of the (2k−1)-th interval to the driving electrode in a 2k interval.

2. The touch sensing apparatus of claim 1, wherein the node capacitor is charged by a positive voltage in a first mode and a negative voltage in a second mode, and
a driving waveform of the first mode and a driving waveform of the second mode are reversed.

3. The touch sensing apparatus of claim 2, wherein, when the driving signal applied to the driving electrode in the (2k−1)-th interval and the (2k+1)-th interval has the driving waveform of the first mode, the driving circuit unit applies the driving signal of the driving waveform of the second mode to the driving electrode in the 2k interval.

4. The touch sensing apparatus of claim 2, wherein, when the driving signal applied to the driving electrode in the (2k−1)-th interval and the (2k+1)-th interval has the driving waveform of the second mode, the driving circuit unit applies the driving signal of the driving waveform of the first mode to the driving electrode in the 2k interval.

5. The touch sensing apparatus of claim 1, wherein, when the driving waveform of the driving signal applied to the driving electrode in the (2k−1)-th interval and the (2k+1)-th interval is reversed, the driving circuit unit applies the driving signal of a direct current (DC) waveform to the driving electrode in the 2k interval.

6. The touch sensing apparatus of claim 1, wherein the driving circuit unit generates the driving signals according to a driving matrix comprising N rows corresponding to the number of the driving electrodes and M columns corresponding to the number of subintervals of the certain interval (N and M are natural numbers greater than 1), and
the driving matrix comprises an element of 1 when the node capacitor is charged by the positive voltage and an element of −1 when the node capacitor is charged by the negative voltage in the subinterval.

7. The touch sensing apparatus of claim 6, wherein the driving matrix comprises an element of 0 when the driving waveform of the driving signal applied to the node capacitor is a direct current (DC) waveform.

8. The touch sensing apparatus of claim 6, wherein the driving matrix comprises a 2k-th row element of −1 when a (2k−1)-th row element and a (2k+1)-th row element of the same column are the same as 1, and the 2k-th row element of 1 when the (2k−1)-th row element and the (2k+1)-th row element are the same as −1 in a matrix generated based on a Walsh sequence.

9. The touch sensing apparatus of claim 6, wherein the driving matrix comprises a 2k-th row element of 0 when a (2k−1)-th row element and a (2k+1)-th row element of the same column are different from each other in matrix generated based on a Walsh sequence.

10. A touch sensing apparatus comprising:
a panel comprising a plurality of driving electrodes, a plurality of sensing electrodes crossing the driving electrodes, and a plurality of node capacitors occurring in intersecting points between the driving electrodes having the driving signals applied to and the sensing electrodes; and
a driving circuit unit applying the driving signals to the node capacitors in a certain interval,
wherein, when a polarity of a voltage charged to the node capacitor in a (2k−1)-th interval and a (2k+1)-th interval (k is a natural number greater than 1) of a certain interval is the same, the driving circuit unit applies the driving signal to the node capacitor so as to produce in a 2k interval a different polarity from the polarity of the voltage charged to the node capacitor of the (2k−1)-th interval.

11. The touch sensing apparatus of claim 10, wherein the driving signal comprises one of a first mode driving waveform for applying a positive voltage to the node capacitor, a second mode driving waveform for applying a negative voltage to the node capacitor, and a third mode driving waveform for applying a direct current (DC) voltage to the node capacitor.

12. The touch sensing apparatus of claim 11, wherein the first mode driving waveform and the second mode driving waveform are reversed.

13. The touch sensing apparatus of claim 11, wherein, when the polarity of the voltage charged to the node capacitor in the (2k−1)-th interval and the (2k+1)-th interval (k is a natural number greater than 1) is different, the driving circuit unit applies the driving signal of the third mode driving waveform to the node capacitor in the 2k interval.

14. The touch sensing apparatus of claim 11, wherein the driving circuit unit generates the driving signals according to a driving matrix comprising N rows corresponding to the number of the driving electrodes and M columns corresponding to the number of subintervals of the certain interval (N and M are natural numbers greater than 1), and
the driving matrix comprises an element of 1 when the node capacitor is charged by the positive voltage and an element of −1 when the node capacitor is charged by the negative voltage in the subinterval.

15. The touch sensing apparatus of claim 14, wherein the driving matrix comprises an element of 0 when the driving signal of the third mode driving waveform is applied to the node capacitor in the subinterval.

16. The touch sensing apparatus of claim 14, wherein, when a (2k−1)-th row element and a (2k+1)-th row element of the same column are the same as 1 in a matrix generated according to a Walsh sequence, the driving matrix comprises a 2k-th row element of −1,
when the (2k−1)-th row element and the (2k+1)-th row element are the same as −1, the driving matrix comprises the 2k-th row element of 1, and
when the (2k−1)-th row element and the (2k+1)-th row element are different from each other, the driving matrix comprises the 2k-th row element of 0.

17. The touch sensing apparatus of claim 10, further comprising:
a sensing circuit unit sensing a change in capacitance of the node capacitors; and
a processing unit determining a touch input based on the capacitance change.

18. A method for driving a touch sensing apparatus, comprising:
applying a plurality of driving signals to a plurality of node capacitors in a certain interval;
generating a plurality of sensing signals by sensing a change in capacitance of the node capacitors per driving time of the certain interval; and
determining a touch input using the sensing signals measured per driving time, wherein, when a driving waveform of the driving signal applied to the node capacitor in a (2k−1)-th interval and a (2k+1)-th interval (k is a natural number greater than 1) of the driving time is in the same phase, the applying of the driving signals applies a reverse driving signal of the driving waveform of the driving signal of the (2k−1)-th interval to the node capacitor in a 2k interval.

19. The method of claim 18, wherein, when the driving waveform of the driving signal applied to the node capacitor in the (2k−1)-th interval and the (2k+1)-th interval is reversed, the applying of the driving signals applies the driving signal of a direct current waveform to the node capacitor in the 2k interval.

20. The method of claim 18, wherein the applying of the driving signals generates the driving signals according to a driving matrix comprising N rows corresponding to the number of the node capacitors and M columns corresponding to the number of the driving times (N and M are natural numbers greater than 1), and
the driving matrix comprises an element of 1 when the node capacitor is charged by a positive voltage and an element of −1 when the node capacitor is charged by a negative voltage, at one driving time.
